(19) United States
(12) Patent Application Publication
(10) Pub. No.: US 2016/0289905 A1
(43) Pub. Date: Oct. 6, 2016

(54) Systems, Devices, and/or Methods for Managing Pet Waste

(71) Applicant: June L. Coutee, Gary, IN (US)

(72) Inventor: June L. Coutee, Gary, IN (US)

(21) Appl. No.: 15/180,033

(22) Filed: Jun. 12, 2016

Related U.S. Application Data
(63) Continuation-in-part of application No. 14/280,585, filed on May 17, 2014.

(51) Int. Cl. E01H 1/12; A01K 1/01

(52) U.S. Cl. CPC E01H 1/1206; A01K 1/01; E01H 2001/1226

(57) ABSTRACT

Certain exemplary embodiments can provide a system that comprises a scoop and a flexible bag. The scoop can define a plurality of apertures. The flexible bag can define a plurality of apertures. The plastic bag can be placed over the scoop and a opening band comprised by the plastic bag can be drawn in such that an opening of the plastic bag has a substantially similar diameter to a diameter of a handle of the scoop.

### CROSS-REFERENCES TO RELATED APPLICATIONS

This application is a continuation-in-part of, and incorporates by reference herein in its entirety, pending U.S. patent application Ser. No. 14/280,585, filed May 17, 2014.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a plan view of an exemplary embodiment of a system;

FIG. 2 is a plan view of an exemplary embodiment of the system; and

FIG. 3 is a plan view of an exemplary embodiment of the system.

### DETAILED DESCRIPTION

Certain exemplary embodiments can provide a system that comprises a scoop and a flexible bag. The scoop can define a plurality of apertures. The flexible bag can define a plurality of apertures. The plastic bag can be placed over the scoop and a opening band comprised by the plastic bag can be drawn in such that an opening of the plastic bag has a substantially similar diameter to a diameter of a handle of the scoop.

The Poo Protector is a plastic bag that is placed over a conventional pet waste scooper to protect the user from coming into contact with the waste itself. The plastic bag is completely disposable after utilizing and saves time with regards to having to wash and clean the scoop. The bag fits snugly over the pet waste scoop and can be easily removable when used.

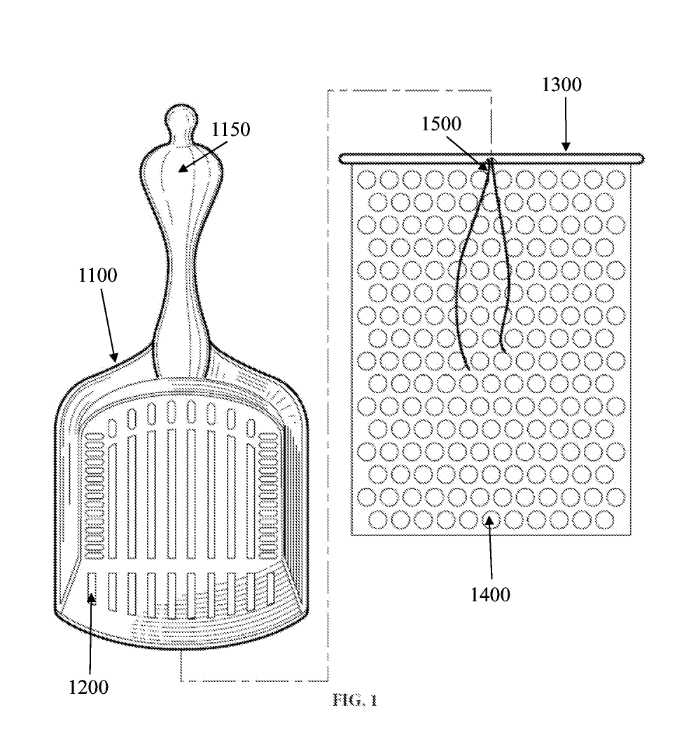

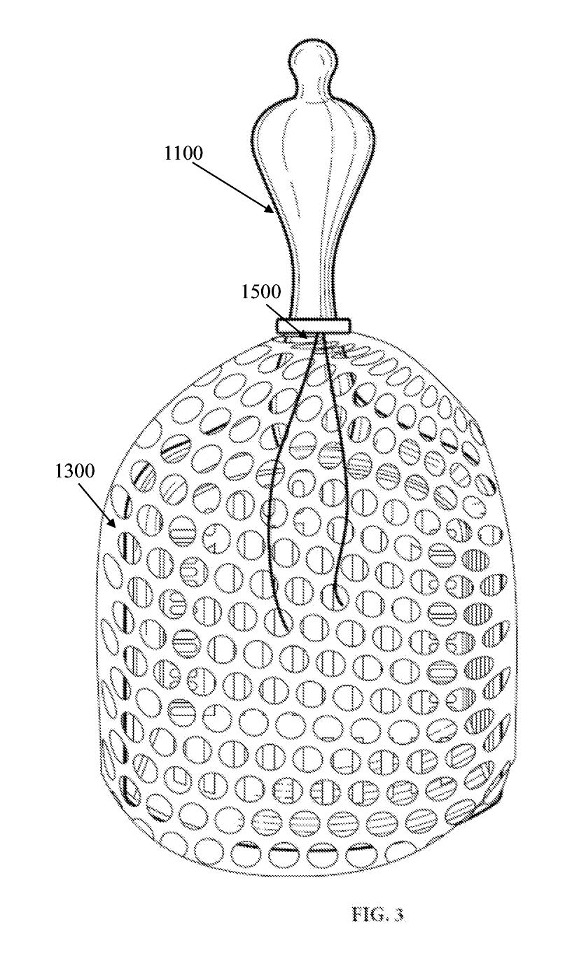

FIG. 1 is a plan view of an exemplary embodiment of a system, which comprises a scoop 1100 that defines a plurality of apertures 1200. The system comprises a flexible bag 1300. Flexible bag 1300 defines a plurality of apertures 1400. Plurality of apertures 1400 causes flexible bag 1300 to retain particles having a diameter greater than a diameter of a smallest of plurality of apertures 1400. Plurality of apertures 1400 causes flexible bag 1300 to pass particles having a diameter smaller than the diameter of the smallest of plurality of apertures 1400. Flexible bag 1300 comprises an opening band 1500. Opening band 1500 causes an opening of flexible bag 1300 to be substantially similar to a diameter of a handle 1150 of scoop 1100 when opening band 1500 is drawn as illustrated in FIG. 3. Opening band 1500 is expandable such that flexible bag 1300 is invertible over scoop 1100, as illustrated in FIG. 3, when scoop 1100 comprises shoveled particulates.

In certain exemplary embodiments, opening band 1500 is elastic. In certain exemplary embodiments, opening band 1500 is not elastic. Scoop 1100 can comprise plastic. Flexible bag 1300 can comprise plastic. Plurality of apertures 1400 defined by flexible bag 1300 can be substantially circular as illustrated.

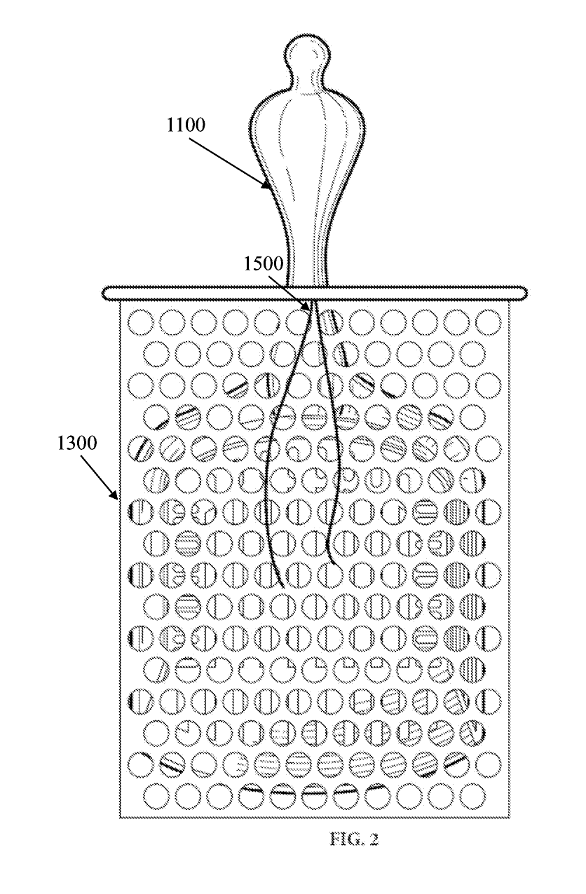

FIG. 2 is a plan view of an exemplary embodiment of the system, which illustrates scoop 1100 with flexible bag 1300 placed over scoop 1100. The illustrated embodiment shows opening band 1500 as not being elastic such that a user can tighten opening band 1500 to effectively couple scoop 1000 to flexible bag 1300.

FIG. 3 is a plan view of an exemplary embodiment of the system, which illustrates scoop 1100 with flexible bag 1300 placed over scoop 1100. The illustrated embodiment shows opening band 1500 as being elastic such that the bag automatically tightens when placed over scoop 1100; or alternatively as not being elastic such that a user can tighten opening band 1500 to effectively couple scoop 1000 to flexible bag 1300.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
and/or—either in conjunction with or in alternative to.
aperture—an opening.
apparatus—an appliance or device for a particular purpose
associate—to join, connect together, and/or relate.
bag—a substantially flexible container that may be closed for holding, storing, or carrying something.
can—is capable of, in at least some embodiments.
cause—to produce an effect.
circular—having a substantially round shape.
comprising—including but not limited to.
configure—to make suitable or fit for a specific use or situation.
connect—to join or fasten together.
constructed to—made to and/or designed to.
convert—to transform, adapt, and/or change.
coupleable—capable of being joined, connected, and/or linked together.
coupling—linking in some fashion.
create—to bring into being.
define—to establish the outline, form, or structure of.
device—a machine, manufacture, and/or collection thereof.
diameter—length of a substantially straight line through an approximate center of an object.
draw—to cause to move toward.
elastic—capable of recovering size and shape after deformation.
expand—to increase in size.
flexible—pliable.
handle—a part that is constructed to be grasped by the hand.
install—to connect or set in position and prepare for use.
invert—to turn inside out.
may—is allowed and/or permitted to, in at least some embodiments.
method—a process, procedure, and/or collection of related activities for accomplishing something.
opening—an aperture at a top of a bag that allows something to be placed in the bag.
opening band—a strip that substantially surrounds an top of a bag and allows the top of the bag to be closed.
particle—a piece of solid matter.
pass—to move past a surface.
plastic—any of a group of synthetic or natural organic materials that may be shaped when soft and then hardened, including many types of resins, resinoids, polymers, cellulose derivatives, casein materials, and proteins.
plurality—the state of being plural and/or more than one.
predetermined—established in advance.
provide—to furnish, supply, give, and/or make available.
receive—to get as a signal, take, acquire, and/or obtain.
retain—to hold.
scoop—a utensil usable as a shovel.
set—a related plurality.
shovel—to pick up with a scoop.
similar—differing at most by a slight amount.
smaller—having a lesser size.
smallest—least is size.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:

there is no requirement for the inclusion of any particular described or illustrated characteristic, function, activity, or element, any particular sequence of activities, or any particular interrelationship of elements;

no characteristic, function, activity, or element is “essential”;

any elements can be integrated, segregated, and/or duplicated;

any activity can be repeated, any activity can be performed by multiple entities, and/or any activity can be performed in multiple jurisdictions; and

any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a scoop, said scoop defining a plurality of apertures;
a flexible bag, said flexible bag defining a plurality of apertures, said plurality of apertures causing said flexible bag to retain particles having a diameter greater than a diameter of a smallest of said plurality of apertures, said plurality of apertures causing said flexible bag to pass particles having a diameter smaller than said diameter of said smallest of said plurality of apertures, said flexible bag comprising an opening band, said opening band causing an opening of said flexible bag to be substantially similar to a diameter of a handle of said scoop when said opening band is drawn, said opening band expandable such that said flexible bag is invertible over said scoop when said scoop comprises shoveled particulates.

2. The system of claim 1, wherein:
said opening band is elastic.

3. The system of claim 1, wherein:
said opening band is not elastic.

4. The system of claim 1, wherein:
said scoop comprises plastic.

5. The system of claim 1, wherein:
said flexible bag is plastic.

6. The system of claim 1, wherein:
said plurality of apertures defined by said flexible bag are substantially circular.
